(19) United States
(12) Patent Application Publication
(10) Pub. No.: US 2023/0203797 A1
(43) Pub. Date: Jun. 29, 2023

(54) CAPACITIVE SENSING FAUCET SYSTEM

(71) Applicant: Masco Canada Limited, St. Thomas (CA)

(72) Inventors: Paul McLennan, London (CA); Ahmad Mousavi, London (CA); Xianliang Lu, London (CA)

(21) Appl. No.: 18/090,793

(22) Filed: Dec. 29, 2022

Related U.S. Application Data
(60) Provisional application No. 63/294,722, filed on Dec. 29, 2021.

(51) Int. Cl. E03C 1/05; E03C 1/04; B05B 12/12

(52) U.S. Cl. CPC E03C 1/057; E03C 1/0404; B05B 12/122

(57) ABSTRACT

A capacitive sensing faucet includes a water faucet and a soap dispenser operably coupled to a capacitive sensor. A controller is in electrical communication with the capacitive sensor and activates either the water faucet or soap dispenser by comparing output signal levels from the capacitive sensor measured on the water faucet and soap dispenser.

### CROSS-REFERENCE TO RELATED APPLICATION

The present application claims priority to U.S. Provisional Patent Application Ser. No. 63/294,722, filed Dec. 29, 2021, the disclosure of which is expressly incorporated herein by reference.

### BACKGROUND AND SUMMARY OF THE DISCLOSURE

The present disclosure relates generally to a faucet system and, more particularly, to an electronic faucet system including a water faucet and a soap dispenser which both include capacitive sensing.

Electronic faucets using capacitance sensing or infra-red (IR) sensing for faucet activation are known in the art. Electronic soap dispensers typically use independent hands-free IR sensors. Each conventional device (electronic faucet and electronic soap dispenser) is constructed and operated independently from each other and hence require duplicate components (power supply, cables, controller, etc.). This adds to overall cost and complexity during assembly and installation. Two IR sensors in close proximity can also cause interference with each other and are more susceptible to false activations. Separate sensors/controllers can also result in higher maintenance, such as increased battery replacement costs.

The present disclosure relates to an electronic faucet system including a water faucet and a soap dispenser driven by a common controller and sensor module. The faucet system measures the capacitance signal of the water faucet and the soap dispenser to detect a user's hand and decide whether to activate water or soap depending on the signal level measured on the faucet and the soap dispenser. Due to the common controller and sensor module, the faucet system utilizes the existing sensing infrastructure for the faucet to also monitor and activate the soap pump. This helps to improve and simplify installation by minimizing the number of cables and connections and allows for easier setup and activation. Additionally, product cost is reduced due to the ability to utilize the existing sensor infrastructure for the faucet.

In an illustrative faucet system, the soap volume to be dispensed can be adjusted by changing a setting on the soap pump module. The faucet system illustratively also includes software algorithms to compare the ratio of signals between the faucet and the soap dispenser to predict the direction of movement of a user's hand and reject unwanted or false activations. The system includes hardware implementing software configured to detect and differentiate between water and soap activation.

The sensor design in the present disclosure can be used in a single unit mode (faucet only) or double unit mode (faucet+soap dispenser). The system of the present disclosure also helps eliminate the possibility of capacitive interference between two separate dispensers. For example, a capacitive sensor can scan the faucet and the soap dispenser in series to prevent signal noise or interference from electrical components (e.g., solenoid valve, pump motor, etc.).

The illustrative faucet system includes several additional features including a maintenance mode and soap priming. These features can be activated by touching or holding one or both of the faucet and the soap dispenser in a specific sequence and/or duration of time. The faucet system also includes software algorithms that allow for calibration due to environmental conditions or installation effects that impact sensor responsiveness, and for signal filtering. The faucet system may also utilize an unused capacitance sensing channel from the sensor module to measure soap level in the dispenser and warn the user of low soap levels. Other features, such as detection between different types of soaps (liquid, foam, etc.) can also be included in the illustrative faucet system.

The illustrative capacitive sensing faucet system of the present disclosure provides for improved activation response based upon a capacitive signal ratio between the water faucet spout and the soap dispenser spout. According to an illustrative method of operation, a capacitive signal level is measured on the water faucet spout and the soap dispenser spout. A signal ratio is then calculated between the capacitive signal levels between water faucet spout and the soap dispenser spout to determine relative hand position. Changes in the ratio may be used to determine if a user's hand is approaching or departing the water faucet spout and/or the soap dispenser spout. The signal ratio may be used to dynamically lower activation thresholds for the water faucet and/or the soap dispenser thereby increasing the respective activation range which reduces response time. Improved response time permit lower scan rates thereby improving battery life.

According to an illustrative embodiment of the present disclosure, a capacitive sensing faucet system includes a water faucet having an electrically operable valve and a capacitive sensor. A soap dispenser includes a soap pump and is operably coupled to the capacitive sensor. A controller is in electrical communication with the capacitive sensor and is configured to receive output signals from the capacitive sensor. The controller activates either the water faucet or the soap pump to dispense water or soap, respectively, based on the output signals from the capacitive sensor measured on the water faucet and the soap dispenser.

According to another illustrative embodiment of the present disclosure, a capacitive sensing faucet system includes a water faucet and a soap dispenser. The water faucet includes a faucet spout defining a water outlet, and an electrically operable valve fluidly coupled to the water outlet. The soap dispenser includes a dispenser spout defining a soap outlet, and a soap pump fluidly coupled to the soap outlet. A capacitive sensor is operably coupled to the faucet spout and the dispenser spout. A controller is operably coupled to the capacitive sensor and is configured to receive a capacitive faucet signal and a capacitive soap signal from the capacitive sensor. The controller is configured to calculate a signal ratio between the capacitive faucet signal and the capacitive soap signal to determine the location of a user's hand relative to the faucet spout and the dispenser spout. The controller activates one of the electrically operable valve of the water faucet or the soap pump of the soap dispenser based upon the signal ratio.

According to a further illustrative embodiment of the present disclosure, a capacitive sensing faucet system includes a water faucet having a faucet spout defining a water outlet, and an electrically operable valve fluidly coupled to the water outlet. A soap dispenser includes a dispenser spout defining a soap outlet, and a soap pump fluidly coupled to the soap outlet. A capacitive sensor is operably coupled to the faucet spout and the dispenser spout. A controller is operably coupled to the capacitive sensor and is configured to receive a capacitive faucet signal and a capacitive soap signal from the capacitive sensor. The controller calculates a signal ratio between the capacitive faucet signal and the capacitive soap signal to determine the location of a user's hand relative to the faucet spout and the dispenser spout, and detects the movement of the user's hand by calculating changes in the signal ratio. The controller activates one of the electrically operable valve of the water faucet or the soap pump of the soap dispenser based upon the signal ratio and the changes in the signal ratio.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a top perspective view of a capacitive sensing faucet system according to an illustrative embodiment of the present disclosure, with a sink shown in phantom;

FIG. 2 is a bottom perspective view of the capacitive sensing faucet system of FIG. 1;

FIG. 3 is a partially exploded perspective view of the faucet control module of FIG. 1;

FIG. 4 is a block diagram of the capacitive sensing faucet system of FIG. 1;

FIG. 5 is an exploded perspective view of the faucet sensor assembly showing the coupling clip removed from the faucet mounting shank;

FIG. 6 is a perspective view of the soap spout sensor assembly showing the coupling clip removed from the spout mounting shank;

FIG. 7 is a top perspective view of a capacitive sensing faucet system according to another illustrative embodiment of the present disclosure;

FIG. 8 is a block diagram of the capacitive sensing faucet system of FIG. 7;

FIG. 9 is a perspective view of an illustrative soap pump and reservoir for use with the capacitive sensing faucet system of FIG. 1;

FIGS. 10A and 10B is a flow chart of an illustrative method of operation of the capacitive sensing faucet system of FIG. 1;

FIG. 11 is a graphical representation of a capacitive signal ratio associated with the illustrative method of operation of FIGS. 10A and 10B;

FIG. 12 is a graph showing faucet and soap capacitive signals relative to time;

FIG. 13A is a flow chart of an illustrative cleaning mode of operation of the capacitive sensing faucet system of FIG. 1; and

FIG. 13B is a flow chart of an illustrative soap priming mode of operation of the capacitive sensing faucet system of FIG. 1.

### DETAILED DESCRIPTION OF THE DRAWINGS

For the purposes of promoting an understanding of the principles of the present disclosure, reference will now be made to the embodiments illustrated in the drawings, which are described herein. The embodiments disclosed herein are not intended to be exhaustive or to limit the invention to the precise form disclosed. Rather, the embodiments are chosen and described so that others skilled in the art may utilize their teachings. Therefore, no limitation of the scope of the claimed invention is thereby intended. The present invention includes any alterations and further modifications of the illustrated devices and described methods and further applications of principles in the invention which would normally occur to one skilled in the art to which the invention relates.

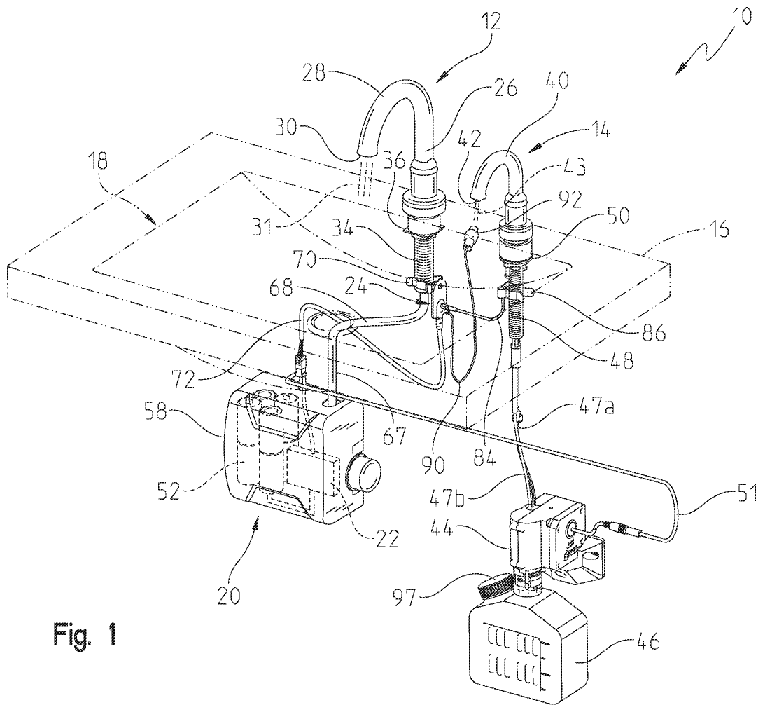

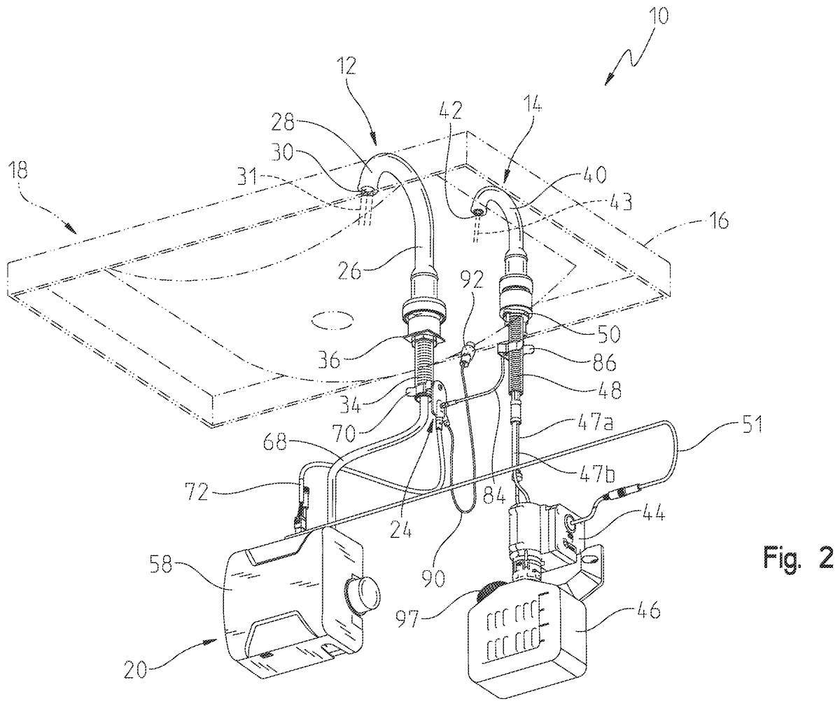

With reference initially to FIGS. 1-2, an illustrative capacitive sensing faucet system 10 includes an electronic water faucet 12 and an electronic soap dispenser 14 supported by a sink deck 16 supporting a sink basin 18. As further detailed herein, the water faucet 12 and the soap dispenser 14 are operably coupled to a common controller and sensor module or assembly 20. The controller and sensor module 20 illustratively includes a controller 22 operably coupled to a capacitive sensor module or assembly 24.

The illustrative electronic water faucet 12 includes a water faucet body 26 having a water faucet spout 28 defining a water outlet 30. The faucet spout 28 extends above the sink deck 16 such that the water outlet 30 discharges water 31 into the sink basin 18. An electrically operable valve 32 is fluidly coupled to the water outlet 30. The faucet body 26 further includes a faucet mounting shank 34 extending downwardly from the faucet spout 28 and below the sink deck 16. A conventional mounting nut 36 is operably coupled to the mounting shank 34 and secures the faucet spout 28 to the sink deck 16. The faucet spout 28 and the mounting shank 34 illustratively each include at least a portion formed of an electrically conductive material, such as a metal. In some illustrative embodiments, the faucet spout 28 and/or the mounting shank 34 may be formed of a plated brass. In other illustrative embodiments, the faucet spout 28 and/or the mounting shank 34 may include a metal or polymer body having a conductive coating (such as chrome plate or antimicrobial copper).

The illustrative electronic soap dispenser 14 includes a soap dispenser body 38 having a soap dispenser spout 40 defining a soap outlet 42 for dispensing soap 43. The dispenser spout 40 extends about the sink deck 16. An electrically operable soap pump 44 fluidly couples a soap reservoir 46 to the soap outlet 42 via a soap supply tube 47a. An air line or supply tube 47b may also extend between the soap reservoir 46 and the soap outlet 42. The soap pump 44 may be of conventional design and is configured to draw soap 43 from the reservoir 46 and dispense it from the soap outlet 42. A dispenser mounting shank 48 extends downwardly from the dispenser spout 40 and below the sink deck 16. A conventional mounting nut 50 is operably coupled to the mounting shank 48 and secures the dispenser spout 40 to the sink deck 16. The soap dispenser spout 40 and the mounting shank 48 illustratively each include at least a portion formed of an electrically conductive material, such as a metal. In some illustrative embodiments, the dispenser spout 40 and/or the mounting shank 48 may be formed of a plated brass. In other illustrative embodiments, the dispenser spout 40 and/or the mounting shank 48 may include a metal or polymer body having a conductive coating (such as chrome plate or antimicrobial copper).

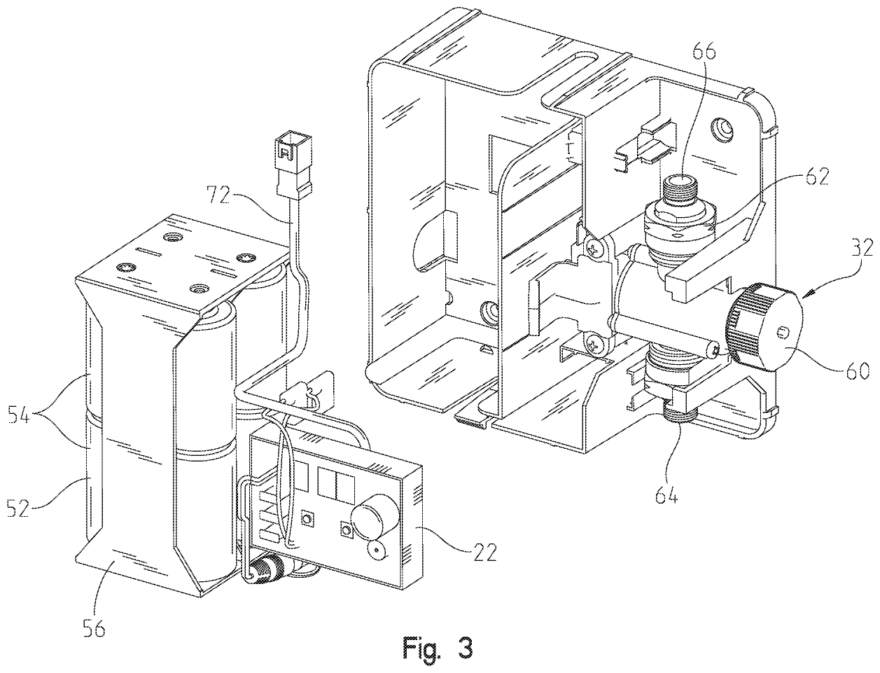

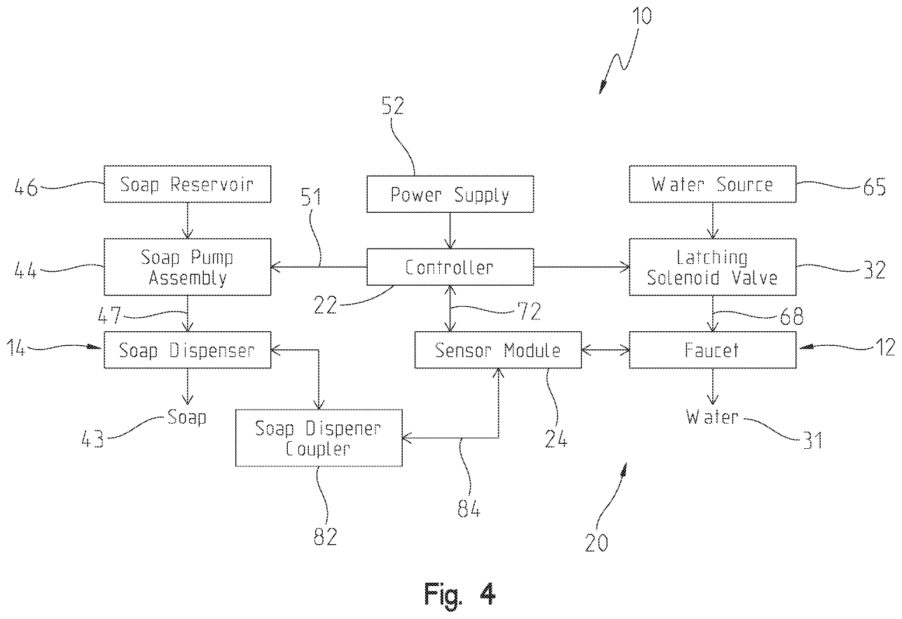

The controller 22 is operably coupled to the soap pump 44, illustratively via a signal cable 51, illustratively a multi-conductor cable. More particularly, the signal cable 51 is configured to provide control signal and power from the controller 22 to the soap pump 44. The controller 22 is illustratively supplied power through a power supply 52 (e.g. battery, wall transformer or AC mains supply). As shown in FIG. 3, the power supply 52 includes a plurality of batteries 54 supported within a holder 56. The controller 22 and the power supply 52 are illustratively received within a housing or case 58. In an illustrative embodiment, the electrically operable valve 32 is also received within the housing 58 and is in electrical communication with the controller 22.

The electrically operable valve 32 may include a solenoid valve 60 received within a valve body 62 having a water inlet 64 and a water outlet 66. The solenoid valve 60 may be a direct current (DC) latching solenoid valve of conventional design. The solenoid valve 60 controls water flow from the inlet 64 to the outlet 66 in a known manner. An illustrative solenoid valve 60 may be similar to the type detailed in U.S. Pat. No. 9,458,612, the disclosure of which is expressly incorporated herein by reference. The inlet 64 is fluidly coupled to a water source 65 (e.g., a conventional water stop or mixing valve), and the outlet 66 is fluidly coupled to the water outlet 30 via an outlet tube 68.

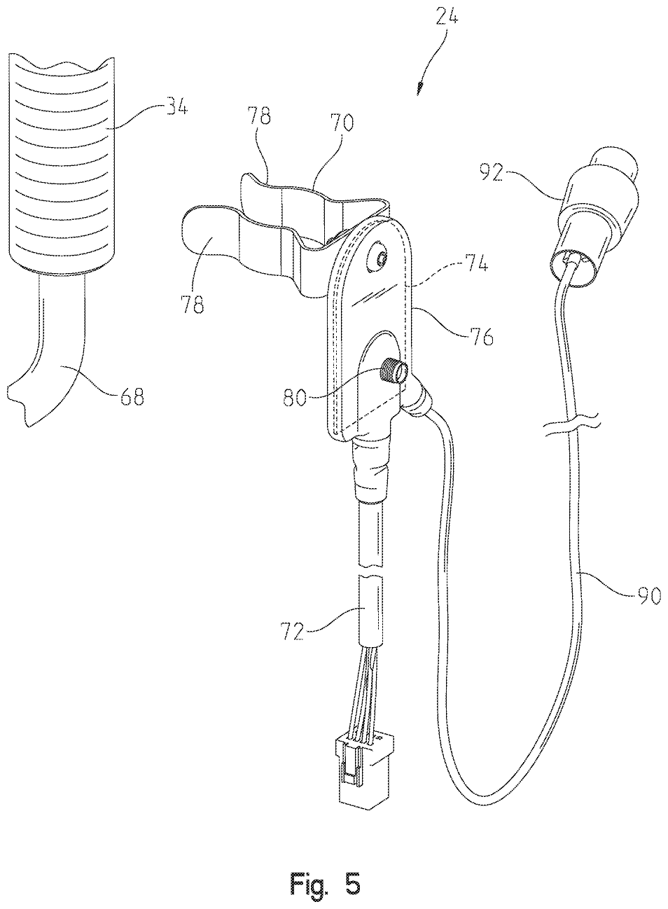

With reference to FIG. 5, the capacitance sensor assembly 24 is illustratively electrically coupled to the conductive mounting shank 34 of the faucet body 26 via an electrical connector, such as a metal spring clip 70 for easy attachment and positioning. A first conductive wire or signal cable, illustratively a shielded co-axial cable 72 couples the capacitive sensor assembly 24 to the controller 22. More particularly, the sensor assembly 24 includes a capacitive sensor 74 received within a body 76, illustratively formed of a polymer. The clip 70 includes opposing spring biased arms 78, illustratively formed of a metal, supported by the body 74 and electrically coupled to the capacitive sensor 74 and a terminal 80.

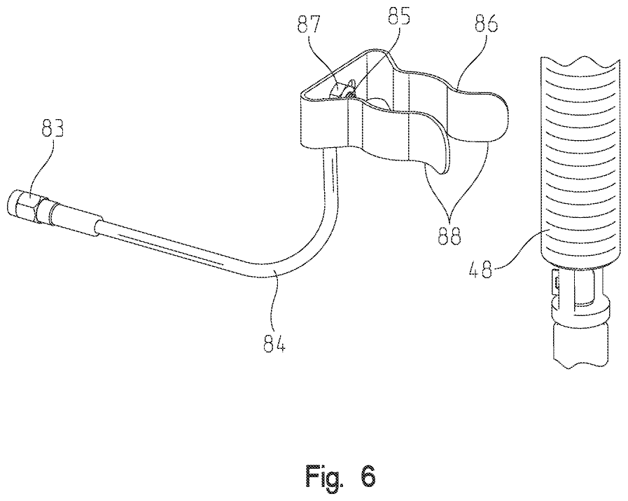

With reference to FIG. 6, a soap dispenser coupler 82 includes a second conductive wire or signal cable, illustratively a shielded co-axial cable 84 mechanically and electrically connected to the sensor assembly 24 using a connector 83, illustratively an RF style connector (SMA, F-type, etc.) for coupling to the terminal 80 of the capacitive sensor assembly 24. The opposite end of the co-axial cable 84 has a terminal 85 and a spring clip 86 connected thereto via a fastener (e.g., nut 87), and is attached to the conductive shank 48 of the soap dispenser body 38 below the sink deck 16 (FIGS. 1 and 2). The clip 86 includes opposing spring biased arms 88, illustratively formed of a metal.

If the sink deck 16 to which the water faucet 12 and the soap dispenser 14 are mounted are constructed of a conductive material (e.g. stainless steel), plastic isolators may be installed to reduce the stray capacitance of the capacitive sensor 74 and improve performance. In certain illustrative embodiments including a conductive sink deck 16 and/or sink basin 18, a grounding cable 90 may be electrically coupled to the capacitive sensor 74 and to a metal ground (e.g., the metal sink basin 18) via a connector 92, such as a clamp or alligator clip, in order to prevent false activations and improve performance.

It should be appreciated that the method and apparatus detailed herein may be used in connection with the faucet disclosed in PCT International Patent Application Publication No. WO 2008/088534, and U.S. Pat. No. 7,690,395, the disclosures of which are expressly incorporated herein by reference. Furthermore, any conventional capacitive sensor may be used in accordance with the present invention. See, for example, U.S. Pat. No. 6,962,168 which is expressly incorporated herein by reference.

The water faucet body 26 and the soap dispenser body 38 provide a functional and aesthetic mechanism to dispense consumables to the user (water or soap), but they also act as an unobtrusive antenna (i.e., electrode) for detecting user presence through changes in detected capacitance. The capacitive sensing faucet system 10 can detect an object, for example a user's hand, by measuring the capacitance signal of the water faucet body 26 and the soap dispenser body 38 and decide whether to activate water or soap depending on the signal level measured.

The capacitive sensor module 24 of the illustrative system 10 processes the signal to detect when a user's hand is near the water faucet 12 or the soap dispenser 14. Once an activation or deactivation threshold has been reached, the capacitive sensor module 24 communicates the command via digital communication to the controller 22. The controller 22 processes the command to open or close the solenoid valve 60 for water faucet 12 operation, or the controller 22 sends a digital signal to the soap pump 44 to dispense soap 43 from the soap reservoir 46.

The digital input/output (I/O) signal is illustratively a 3V square wave pulse for ˜1 to 1.5 seconds in duration. Two channels are illustratively implemented for signals to the soap dispenser 14. A first channel is for normal soap pump 44 activation, and a second channel is for soap pump 44 priming (as further detailed herein). In an illustrative embodiment, the controller 22 also provides power to the soap pump 44 from the common power supply 52 (e.g. battery, wall transformer or AC mains supply).

The soap pump 44 is illustratively connected to the soap dispenser 14 by soap supply tube 47a and the air supply tube 47b, and includes an internal processor circuit. Soap volume can be adjusted by changing a setting on the soap pump 44. The soap pump 44 can be also be “primed” after the reservoir 46 has been replenished with soap by touching or holding one of both of the water faucet spout 28 and the soap dispenser spout 40 in a specific sequence and/or for a specific duration of time (as further detailed herein). The controller 22 recognizes this unusual activation sequence and sends a control signal to the soap pump 44 to initialize a priming operation (run soap pump motor continuously for a fixed period of time, e.g. 15 to 30 seconds). In one illustrative embodiment, the controller 22 allows two consecutive priming cycles after which the priming function is disabled for a period of thirty minutes to prevent vandalism or malicious operation.

In one illustrative embodiment, the capacitance signal from the soap dispenser 14 is transmitted to the sensor unit 24 via short co-axial cable 84, providing shielded protection to the signal wire and preventing interference. In another illustrative embodiment, a signal wire with a foil shield may be used. In yet another illustrative embodiment, an “energized shield” may also be applied to the cable shield to reduce radiated interference.

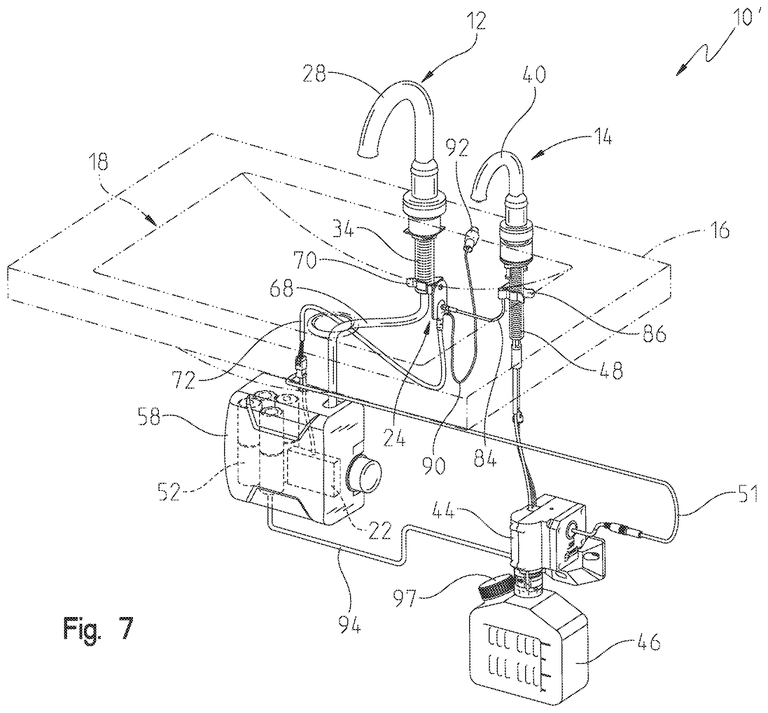

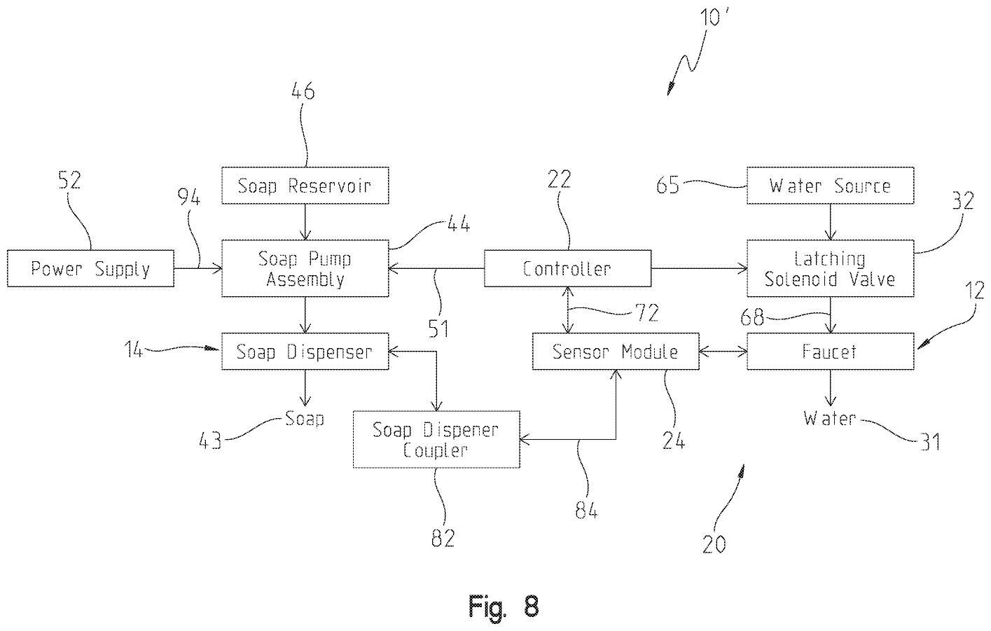

FIGS. 7 and 8 shows a further illustrative embodiment capacitive sensing faucet system 10′ including the electronic water faucet 12 and the electronic soap dispenser 14. The capacitive sensing faucet system 10′ is similar to capacitive sensing faucet system 10, wherein similar features are identified with the same reference numbers. One difference with the capacitive sensing faucet system 10′ is that it includes the power supply 52 being directly coupled to the soap pump 38, illustratively via a power cable 94. The signal cable 51 still provides control signals between the controller 22 and the soap pump 44.

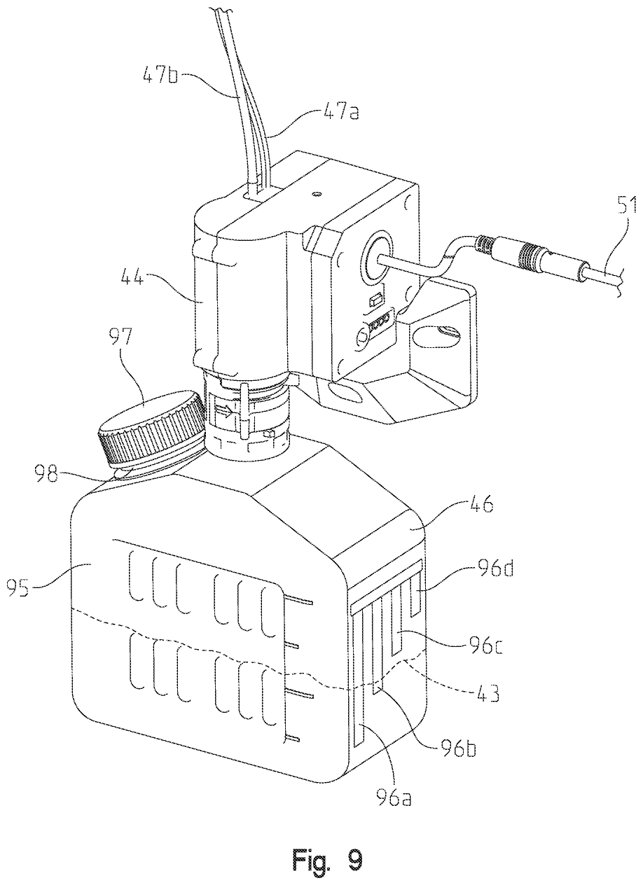

Additional unused capacitance sensing channels from the sensor module 24 can be used, illustratively via proximity sensing technology, to measure soap levels in the soap reservoir 46 and warn the user of a low soap level. With reference to FIG. 9, an illustrative soap reservoir 46 may include a polymeric container or bottle 95 supporting a plurality of conductive traces 96a, 96b, 96c, 96d for detecting the level of soap 43 received therein. The conductive traces 96a, 96b, 96c, 96d are illustratively formed of metal (e.g., copper) and are in electrical communication with the controller 22 (via capacitive channels in the sensor module 24). The traces 96a, 96b, 96c, 96d have different lengths corresponding to different depths within the container 95. As such, the controller 22 can determine a relative level of soap 43 based upon the output signals received from the different traces 96a, 96b, 96c, 96d. When the detected level falls below a predetermined value, the controller 22 may provide an alert to the user via a light or audible indicator. A removable cap 97 may cover a fill port 98 of the container 95 for refilling the soap reservoir 46 with soap 43.

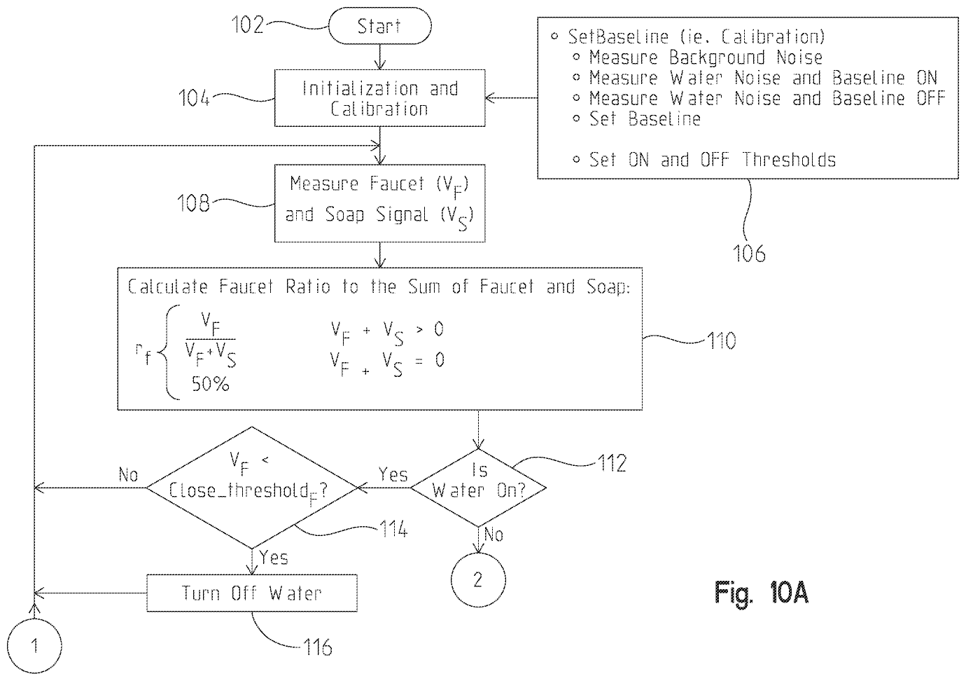

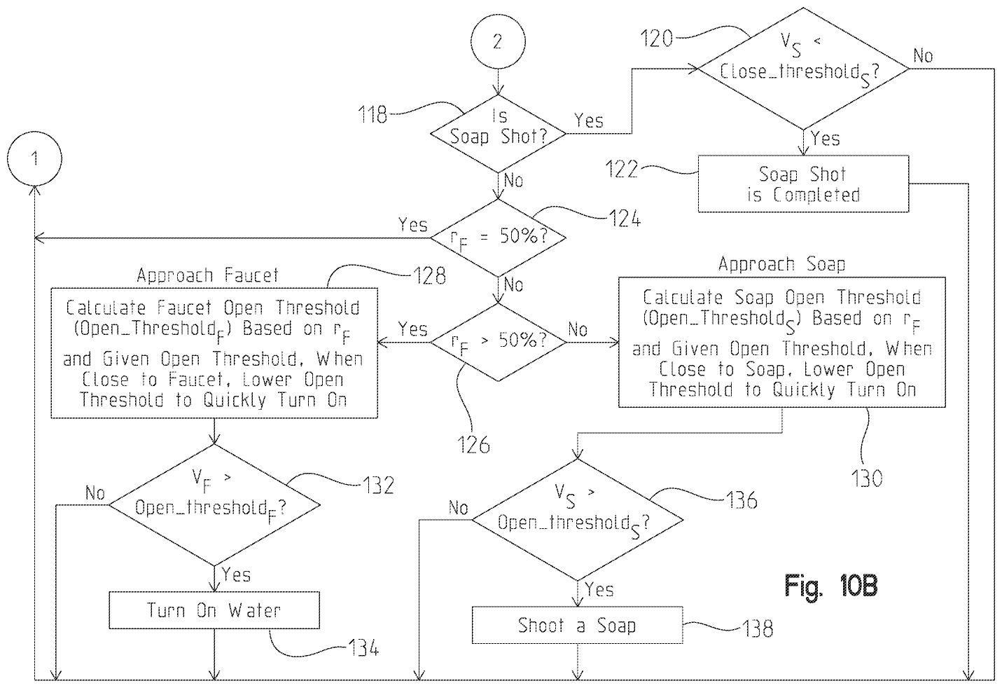

With reference now to FIGS. 10A and 10B, an illustrative method of operation of the capacitive sensing faucet system 10 is shown beginning at block 102. At block 104, the controller 22 executes initialization and calibration. As shown by block 106, during initialization and calibration, signal baselines and ON/OFF thresholds are set. Illustratively, the controller 22 measures electrical signal noise, including power supply noise (e.g, battery, transformer, etc.), and background noise (e.g., sink, temperature, environmental, etc.). The controller 22 also measures electrical signal noise when water is ON (i.e., electrically operable valve 32 is open), and when water is OFF (i.e., electrically operable valve 32 is closed). Using these noise measurements, the controller 22 sets a baseline capacitive signal value, and also establishes an ON or open threshold capacitive signal value for the faucet 12 (Open_threshold_{F}), an OFF or close threshold capacitive signal value for the faucet 12 (Close_threshold_{F}), an ON or open threshold capacitive signal value for the soap dispenser 14 (Open_threshold_{S}), and an OFF or close threshold capacitive signal value for the soap dispenser 14 (Close_threshold_{S}).

After initialization and calibration, the process continues to block 108, where the capacitive sensor 74 scans or measures capacitance at the faucet body 26 to provide a capacitive faucet signal (V_{F}) to the controller 22, and scans or measures capacitance at the soap dispenser body 38 to provide a capacitive soap signal (V_{S}) to the controller 22. In other words, the capacitive sensor 74 measures capacitance at the faucet spout 28 and the soap dispenser spout 40.

Next at block 110, the controller 22 calculates a faucet ratio (r_{f}) equal to the capacitive faucet signal (V_{F}) divided by the sum of the capacitive faucet signal (V_{F}) and the capacitive soap signal (V_{S}). If the sum of the capacitive faucet signal (V_{F}) and the capacitive soap signal (V_{S}) is greater than 0, then the controller 22 can determine than an object (e.g., user's hand) is present between the faucet spout 28 and the soap dispenser spout 40, and is positioned closer to the faucet spout 28. If the faucet ratio (r_{f}) is equal to 50%, then the controller 22 can determine that either no object (e.g., user's hand) is present between the faucet spout 28 and the soap dispenser spout 40, or an object (e.g., user's hand) is positioned equal distance between the faucet spout 28 and the soap dispenser spout 40. Similarly, if the sum of the capacitive faucet signal (V_{F}) and the capacitive soap signal (V_{S}) is equal to 0, then the controller 22 can determine that either no object (e.g., user's hand) is present between the faucet spout 28 and the soap dispenser spout 40, or an object (e.g., user's hand) is positioned equal distance between the faucet spout 28 and the soap dispenser spout 40.

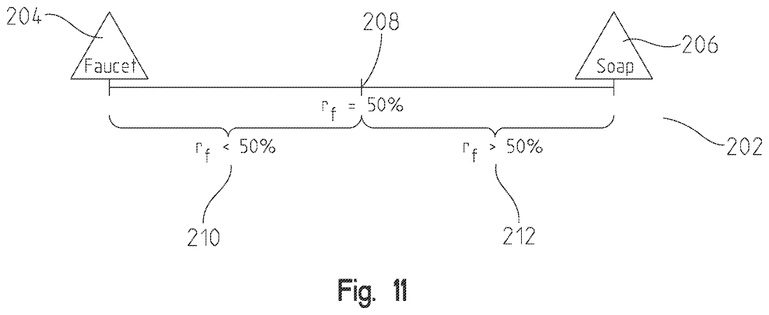

FIG. 11 is a graphical representation of the faucet ratio (r_{F}) 202 relative to the faucet spout body 26 and the spout dispenser body 38, where the faucet body is graphically represented by reference number 204, and the soap dispenser body 38 is graphically represented by reference number 206. The faucet ratio (r_{F}) when a user's hand is at an equal distance (50%) between the faucet spout body 204 and the soap dispenser body 206 is represented by reference number 208. Reference number 210 represents the faucet ratio (r_{F}) being less than 50% when the user's hand is closer to the faucet spout body 204 than the soap dispenser body 206, while reference number 212 represents the faucet ratio (r_{F}) being greater than 50% when the user's hand is closer to the soap dispenser body 206 than the faucet spout body 204.

The process continues at block 112, where the controller 22 determines whether the water is on (i.e., the solenoid valve 60 is open). If yes, then the controller 22 determines if the faucet signal V_{F} is less than the close threshold value (Close_threshold_{F}) at block 114. If no, then the controller 22 returns to block 108 where the capacitive sensor 74 scans for signals at the faucet spout 28 and the soap dispenser spout 40. If yes, then the water is turned off at block 116 by closing the solenoid valve 60. Returning to block 112, if the water is not on (i.e., the solenoid valve 60 is closed), then the process continues to block 118 as shown in FIG. 10B.

With further reference to FIG. 10B, the controller 22 determines if soap 43 is dispensed at block 118 (i.e., the soap pump 44 is operating). If yes, then the controller 22 determines if the capacitive soap signal (V_{S}) is less than the close threshold capacitive signal value for the soap dispenser 14 (Close_threshold_{S}). If not, then the controller 22 returns to the measuring block 108. If yes, then the controller 22 completes the soap dispensing (i.e., soap shot) by deactivating the soap pump 44 at block 122. The controller 22 then again returns to the measurement block 108.

Returning to decision block 118, if the controller 22 determines that soap 43 is not dispensed at block 118 (i.e., the soap pump 44 is not operating), then the process continues to block 124. At block 124, the controller 22 determines if the faucet ratio (r_{F}) equals 50%. As noted above, this indicates that either no object (e.g., user's hand) is present between the faucet spout 28 and the soap dispenser spout 40, or an object (e.g., user's hand) is positioned equal distance between the faucet spout 28 and the soap dispenser spout 40. If yes, then the controller 22 returns to the measurement block 108. If not, then the controller 22 determines if (r_{F}) is greater than 50% at block 126.

If the faucet ratio (r_{F}) is greater than 50% at block 126, then the process continues to block 128 indicating that the object (e.g., user's hand) is closer to the faucet spout 28 than the soap dispenser spout 40. If the faucet ratio (r_{F}) is not greater that 50% at block 126, then the process continues to block 130 indicating that the object (e.g., user's hand) is closer to the soap dispenser spout 40 than the faucet spout 28.

At block 128, the controller 22 utilizes changes in the faucet ratio (r_{F}) to determine that the user's hand is approaching the faucet spout 28. If so, then then controller 22 illustratively adjusts the faucet open threshold value (Open_threshold_{F}). More particularly, the controller 22 may lower the faucet open threshold value (Open_threshold_{F}) so that the electrically operable valve 32 will open more quickly.

At block 130, the controller 22 utilizes changes in the faucet ratio (r_{F}) to determine that the user's hand is approaching the soap dispenser spout 40. If so, then then controller 22 illustratively adjusts the soap open threshold value (Open_threshold_{S}). More particularly, the controller 22 may lower the soap open threshold value (Open_threshold_{S}) so that the soap pump 44 will activate more quickly.

After block 128, the process continues to block 132 where the controller 22 decides if the faucet signal (V_{F}) is greater than the faucet open threshold value (Open_threshold_{F}). If no, then the controller 22 returns to measurement block 108. If yes, then the controller 22 turns on the water at block 134 by opening the solenoid valve 60. The system then returns to the measurement block 108

After block 130, the process continues to block 136 where the controller 22 decides if the faucet signal (V_{S}) is greater than the soap open threshold value (Open_threshold_{S}). If no, then the system returns to the measurement block 108. If yes, then the controller 22 dispenses soap at block 138 by activating the soap pump 44. The system then returns to the measurement block 108.

The controller 22 may execute alternative methods of operating the capacitive sensing faucet system 10. For example, an illustrative method may be based on a time domain rate of change of the capacitive signal ratio (r_{F}). More particularly, the faucet capacitive signal (V_{F}) and the soap dispenser capacitive signal (V_{S}) are sensed and then calculated relative to saturation. Next, the controller 22 calculates the faucet signal ratio (r_{F}) and the rate of change of the faucet ratio (r_{F}). Since this method relies on a rate of change, it requires a more frequent scan rate.

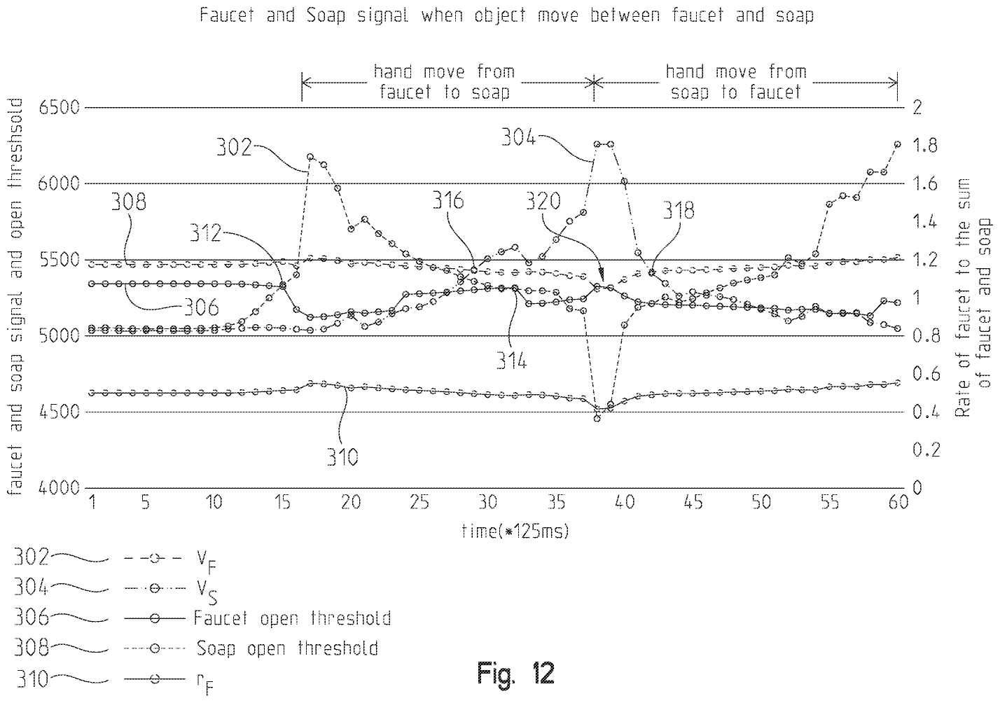

FIG. 12 is a graph illustrating faucet and soap dispenser capacitive signals (V_{F}) and (V_{S}) when an object (e.g., user's hand) moves between the faucet spout 28 and soap dispenser spout 40. The faucet capacitive signal (V_{F}) is represented by points along line 302, while the soap dispenser capacitive signal (V_{S}) is represented by points along line 304. The faucet open threshold (Open_threshold_{F}) and the soap dispenser open threshold (Open_threshold_{S}) are represented by points along lines 306 and 308, respectively. Finally, the faucet signal ratio (r_{F}) is represented by points along the line 310.

With further reference to FIG. 12, at point 312 the faucet capacitive signal (V_{F}) 302 becomes greater than the faucet open threshold (Open_threshold_{F}) 306, such that the controller 22 opens the electrically operable valve 32 such that water 31 is discharged from the water outlet 30 of the faucet spout 28. At point 314, the faucet capacitive signal (V_{F}) 302 becomes less than the faucet open threshold (Open_threshold_{F}) 306, such that the controller 22 closes the electrically operable valve 32 such that water is no longer discharged from the water outlet 30 of the faucet spout 28. At point 316 the soap capacitive signal (V_{S}) 302 becomes greater than the soap open threshold (Open_threshold_{S}) 308, such that the controller 22 activates the soap pump 44 to dispense soap from the outlet 42 of the soap dispenser spout 40. At point 318, the soap capacitive signal (V_{S}) 302 becomes less than the soap open threshold (Open_threshold_{S}) 308, such that the controller 22 deactivates the soap pump 44 and no soap is dispensed from the outlet 42 of the soap dispenser spout 40. Point 320 demonstrates an adjustment of the soap open threshold (Open_threshold_{S}) 308 as the controller 22 detects a user's hand approaching the soap dispenser spout 40.

As may be appreciated from the description herein, by using software algorithms, the capacitive sensing faucet system 10 can reject unwanted/false activations and differentiate the user proximity to the water faucet 12 or the soap dispenser 14 to activate the correct device as the user intended. The software compares the ratio of signals between the water faucet 12 and the soap dispenser 14 to predict the direction of movement of the user's hand to reduce the sensor 74 lag time for activation. The speed and direction of travel of the user's hand can be detected and used to improve the user experience by anticipating the intended action.

Using software algorithms, the illustrative capacitive sensing faucet system 10 can be put into different modes, such as a maintenance mode, to avoid activations while being cleaned. A temporary lockout mode can be an automatic timer (e.g. elapses after 30 seconds) or it can be locked and unlocked using an uncommon user scenario, which would prevent unintended or malicious lockout in public spaces. Lockout could be achieved by touching and holding one or both of the water faucet spout 12 and the soap dispenser spout 14 in a specific sequence or for a specific duration of time. Touching of the water faucet spout 12 and the soap dispenser spout 14 can be easily and quickly distinguished from touchless activation by comparing capacitance signal level to a fully saturated (grounded) signal level. This can be done above deck by maintenance or custodial staff without opening the control box or interacting with a below deck controller (not pictured).

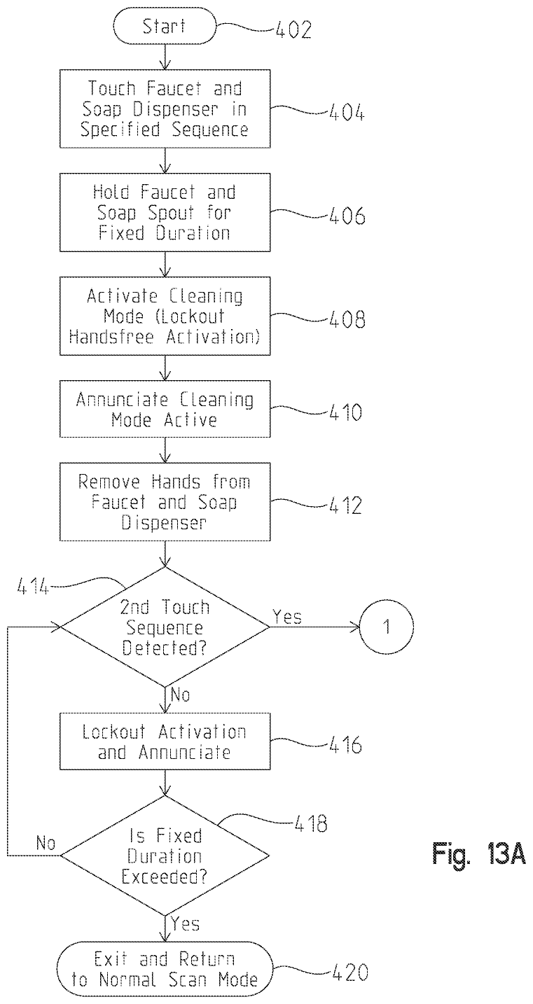

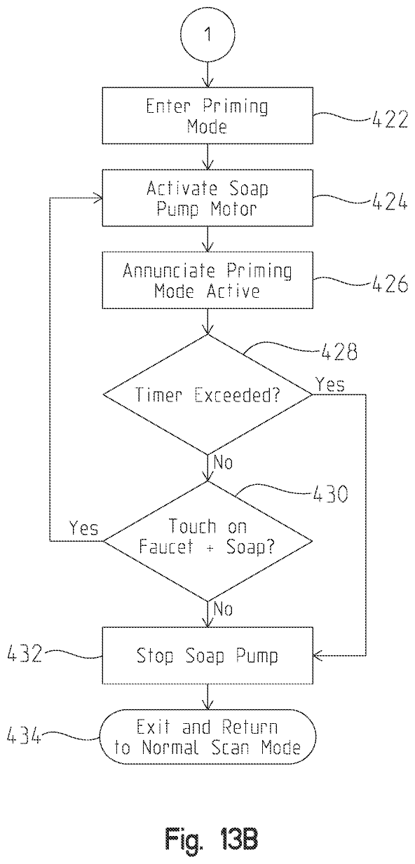

FIG. 13A further details an illustrative cleaning or lockout mode of operation, while FIG. 13B further details an illustrative soap priming mode of operation. The cleaning mode begins at block 402 and when activated, disables or “locks out” capacitive sensing features during a normal mode of operation. If the user touches the faucet spout 28 and the soap dispenser spout 40 in a specified sequence at block 404, and/or if the user holds the faucet spout 28 and the soap dispenser spout 40 for a fixed duration at block 406, the process continues to block 408. More particularly, at block 408 the cleaning mode is activated by the controller 22 which provides for lockout of the normal operating mode (i.e., hands free activation of the faucet 12 and/or soap dispenser 14). Such a lockout activation may be indicated to the user via an audible device, such as a buzzer or annunciator at block 410. The user can then remove his/her hands from the faucet spout 28 and the soap dispenser spout 40 at block 412. At block 414, the controller 22 determines if a second touch sequence is detected. If yes, then the controller 22 may enter a different operating mode, such as the soap priming mode of FIG. 13B.

If no second touch sequence is detected at block 414, then the lockout activation continues and may be further indicated to the user via the audible device at block 416. At block 418, the controller 22 determines if a fixed duration (e.g., 15 to 30 seconds) has been exceeded. If not, then the process returns to decision block 414 of determining if a second touch sequence is detected. If the duration has been exceeded, then the controller 22 exits the cleaning mode and returns to the normal operating mode by scanning for capacitive sensing signals at the faucet spout 28 and the soap dispenser spout 40.

Returning to the decision block 414, if the second touch sequence is detected (e.g., the user touches one or both of the water faucet spout 28 and the soap dispenser spout 40), then the process continues to block 422 of FIG. 13B where the controller 22 enters the soap priming mode. At this step, the soap pump 44 is activated. At block 426, the controller 22 provides an indication to the user that the priming mode is active, illustratively via an audible device, such as a buzzer or annunciator. If a timer is exceeded at block 428 (e.g., if the soap pump 44 is activated for more than a predetermined time (such as 30 seconds)), then the soap pump 44 is deactivated. If the timer is not exceeded at decision block 430, then the controller 22 determines whether the user is touching the faucet spout 28 and the soap dispenser spout 40. If yes, then the controller 22 returns to block 424 and continues activation of the soap pump 44. If no, then the controller 22 proceeds to block 432 where it deactivates the soap pump 44. After the soap pump 44 is stopped at block 432, the controller 22 exits the soap priming mode and returns to the normal operating mode by scanning for capacitive sensing signals at block 434.

As further detailed herein, the capacitive sensing faucet system 10 can be calibrated for increased or decreased activation zones (sensitivity) through the use of software algorithms. Additionally, dynamic calibration (thresholds) can adjust for transient environmental conditions (temperature, humidity, water conductivity, etc.) or installation effects which may impact activation range or responsiveness. Digital and/or analog signal filtering can be used to cancel harmonics and ground noise induced to avoid malfunctions and false activations during use of the capacitive sensing faucet system 10. The capacitance sensor module 24 utilizes “multi-sense converter” technology, which uses a ratio-metric approach to measure capacitance. This has the advantage of making the measurement independent of the supply voltage or transients which can cause false activations or delayed detection response.

Additional details regarding illustrative capacitive thresholds are detailed in U.S. Pat. No. 8,561,626, the disclosure of which is expressly incorporated herein by reference.

Other features, such as detection between different types of soap (liquid, foam, etc.), can also be included in the capacitive sensing faucet system 10. For example, soap type can influence environmental capacitance. By monitoring pump motor current, the controller 22 can differentiate between liquid soap and foaming soap due to a large difference in viscosity. Illustratively, foam soap has a viscosity of less than 10 cP, while liquid soap has a viscosity of between 1500 to 4000 cP. The controller 22 can determine this by measuring a baseline signal before and after priming the pump 44 to distinguish the type of soap loaded into reservoir 46.

Although the invention has been described in detail with reference to certain preferred embodiments, variations and modifications exist within the spirit and scope of the invention as described and defined in the following claims.

What is claimed is:

1. A capacitive sensing faucet system comprising:
a water faucet including an electrically operable valve and a capacitive sensor;
a soap dispenser including a soap pump and operably coupled to the capacitive sensor; and
a controller in electrical communication with the capacitive sensor, the controller configured to receive output signals from the capacitive sensor and to activate either the water faucet or the soap pump to dispense water or soap, respectively, based on levels of the output signals from the capacitive sensor measured on the water faucet and the soap dispenser.

2. The capacitive sensing faucet system of claim 1, wherein the water faucet includes a faucet spout having at least a portion formed of a conductive material.

3. The capacitive sensing faucet system of claim 2, wherein the soap dispenser includes a dispenser spout having at least a portion formed of a conductive material.

4. The capacitive sensing faucet system of claim 3, wherein:
the water faucet further includes a faucet mounting shank extending downwardly from the faucet spout and electrically coupled to the faucet spout;
the soap dispenser further includes a dispenser mounting shank extending downwardly from the dispenser spout and electrically coupled to the dispenser spout;
a faucet mount electrically coupled to the faucet mounting shank;
a dispenser mount electrically coupled to the dispenser spout;
a connecting cable electrically coupling the faucet mount with the dispenser mount; and
a signal cable electrically coupling the faucet mount to the controller.

5. The capacitive sensing faucet system of claim 1, wherein the soap pump is configured to be adjusted to change soap volume dispensed per activation.

6. The capacitive sensing faucet system of claim 1, wherein the controller is configured to detect the movement of a user's hand based upon the output signals from the capacitive sensor as measured on the water faucet and the soap dispenser.

7. The capacitive sensing faucet system of claim 6, wherein the controller is configured to detect the movement of a user's hand by comparing a ratio of output signals from the capacitive sensor as measured on the water faucet and the soap dispenser.

8. The capacitive sensing faucet system of claim 1, wherein soap pump priming is configured to be activated by touching at least one of the water faucet and the soap dispenser in a specific sequence, such that the output signals from the capacitive sensor cause the controller to activate the soap pump for as long as the user is touching the at least one of the water faucet and the soap dispenser subject to a timer.

9. The capacitive sensing faucet system of claim 1, wherein a lockout mode is configured to be activated by touching or holding one or both of the water faucet and soap dispenser in a specific sequence, such that the output signals from the capacitive sensor cause the controller to disable the electrically operable valve or the soap pump, respectively.

10. The capacitive sensing faucet system of claim 1, wherein the output signal measured from the soap dispenser provides an indication to the user of an amount of soap stored in a soap reservoir.

11. A capacitive sensing faucet system comprising:
a water faucet including a faucet spout defining a water outlet, and an electrically operable valve fluidly coupled to the water outlet;
a soap dispenser including a dispenser spout defining a soap outlet, and a soap pump fluidly coupled to the soap outlet;
a capacitive sensor operably coupled to the faucet spout and the dispenser spout;
a controller operably coupled to the capacitive sensor, the controller configured to receive a capacitive faucet signal and a capacitive soap signal from the capacitive sensor;
wherein the controller calculates a signal ratio between the capacitive faucet signal and the capacitive soap signal to determine the location of a user's hand relative to the faucet spout and the dispenser spout; and
wherein the controller activates one of the electrically operable valve of the water faucet or the soap pump of the soap dispenser based upon the signal ratio.

12. The capacitive sensing faucet system of claim 11, wherein the faucet spout includes at least a portion formed of a conductive material, and the dispensing spout includes at least a portion formed of a conductive material.

13. The capacitive sensing faucet system of claim 12, wherein:
the water faucet further includes a faucet mounting shank extending downwardly from the faucet spout and electrically coupled to the faucet spout;
the soap dispenser further includes a dispenser mounting shank extending downwardly from the dispenser spout and electrically coupled to the dispenser spout;
a faucet mount electrically coupled to the faucet mounting shank;
a dispenser mount electrically coupled to the dispenser spout;
a connecting cable electrically coupling the faucet mount with the dispenser mount; and
a signal cable electrically coupling the faucet mount to the controller.

14. The capacitive sensing faucet system of claim 11, wherein the controller is configured to detect the movement of the user's hand by calculating changes in the signal ratio.

15. The capacitive sensing faucet system of claim 14, wherein activation of one of the electrically operable valve of the water faucet or the soap pump of the soap dispenser depends upon the changes in the signal ratio.

16. The capacitive sensing faucet system of claim 11, wherein soap pump priming is configured to be activated by touching at least one of the water faucet and the soap dispenser in a specific sequence, such that the output signals from the capacitive sensor cause the controller to activate the soap pump for as long as the user is touching the at least one of the water faucet and the soap dispenser subject to a timer.

17. The capacitive sensing faucet system of claim 11, wherein a lockout mode is configured to be activated by touching or holding one or both of the water faucet and soap dispenser in a specific sequence, such that the output signals from the capacitive sensor cause the controller to disable the electrically operable valve or the soap pump, respectively.

18. The capacitive sensing faucet system of claim 10, wherein the output signal measured from the soap dispenser provides an indication to the user of an amount of soap stored in a soap reservoir.

19. A capacitive sensing faucet system comprising:
a water faucet including a faucet spout defining a water outlet, and an electrically operable valve fluidly coupled to the water outlet;
a soap dispenser including a dispenser spout defining a soap outlet, and a soap pump fluidly coupled to the soap outlet;
a capacitive sensor operably coupled to the faucet spout and the dispenser spout;
a controller operably coupled to the capacitive sensor, the controller configured to receive a capacitive faucet signal and a capacitive soap signal from the capacitive sensor;
wherein the controller calculates a signal ratio between the capacitive faucet signal and the capacitive soap signal to determine the location of a user's hand relative to the faucet spout and the dispenser spout, and detects the movement of the user's hand by calculating changes in the signal ratio; and
wherein the controller activates one of the electrically operable valve of the water faucet or the soap pump of the soap dispenser based upon the signal ratio, and the changes in the signal ratio.

20. The capacitive sensing faucet system of claim 19, wherein the faucet spout includes at least a portion formed of a conductive material, and the dispensing spout includes at least a portion formed of a conductive material.

21. The capacitive sensing faucet system of claim 20, wherein:
the water faucet further includes a faucet mounting shank extending downwardly from the faucet spout and electrically coupled to the faucet spout;
the soap dispenser further includes a dispenser mounting shank extending downwardly from the dispenser spout and electrically coupled to the dispenser spout;
a faucet mount electrically coupled to the faucet mounting shank;
a dispenser mount electrically coupled to the dispenser spout;
a connecting cable electrically coupling the faucet mount with the dispenser mount; and
a signal cable electrically coupling the faucet mount to the controller.

22. The capacitive sensing faucet system of claim 19, wherein soap pump priming is configured to be activated by touching at least one of the water faucet and the soap dispenser in a specific sequence, such that the output signals from the capacitive sensor cause the controller to activate the soap pump for as long as the user is touching the at least one of the water faucet and the soap dispenser subject to a timer.

23. The capacitive sensing faucet system of claim 19, wherein a lockout mode is configured to be activated by touching or holding one or both of the water faucet and soap dispenser in a specific sequence, such that the output signals from the capacitive sensor cause the controller to disable the electrically operable valve or the soap pump, respectively.

24. The capacitive sensing faucet system of claim 19, wherein the output signal measured from the soap dispenser provides an indication to the user of an amount of soap stored in a soap reservoir.
